(19) United States
(12) Patent Application Publication
(10) Pub. No.: US 2006/0022921 A1
(43) Pub. Date: Feb. 2, 2006

(54) Transmissive liquid crystal display panel and liquid crystal display device using the same

(75) Inventors: Shigenori Miyake, Itami-shi (JP); Seiichirou Mori, Itami-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Mitsubishi Denki Kabushiki Kaisha, Tokyo (JP)

(21) Appl. No.: 11/179,742

(22) Filed: Jul. 13, 2005

(30) Foreign Application Priority Data
Jul. 28, 2004 (JP) 2004-220333

(51) Int. Cl. G09G 3/36

(52) U.S. Cl. 345/87; 349/102

(57) ABSTRACT

In a transmissive liquid crystal display device, a liquid crystal display panel includes an image display portion and a light-receiving window portion. When the ambient light is sufficient, a backlight is turned off and the light-receiving window portion is set to a light-transmitting state, to take the external light into the backside of the liquid crystal display panel so as to display an image. When the ambient light is insufficient, the backlight is turned on and the light-receiving window portion is set to a light-blocking state, to display the image with the light from the backlight. Thus, the device configuration is simplified compared to the case of opening/closing a light-receiving window by using a movable blocking plate.

### BACKGROUND OF THE INVENTION

1. Field of the Invention

The present invention relates to a liquid crystal display panel and a liquid crystal display device using the same, and more particularly to a transmissive liquid crystal display panel consuming low power and a liquid crystal display device using the same.

2. Description of the Background Art

Conventionally, there are known a reflective liquid crystal display device in which a reflecting member is arranged on the back of a liquid crystal display panel and external light reflected by the reflecting member is used to display an image, and a transmissive liquid crystal display device in which a backlight is arranged on the back of a liquid crystal display panel and light from the backlight is used to display an image.

There is also known a transmissive liquid crystal display device that is provided with a light-receiving window in the vicinity of a liquid crystal display panel, which can be opened/closed by a movable blocking plate. When the ambient light is insufficient, a backlight is turned on and the movable blocking plate is closed to use the light from the backlight to display an image. On the other hand, when the ambient light is sufficient, the backlight is turned off and the movable blocking plate is opened so as to use external light taken in from the light-receiving window to display an image (see, e.g., Japanese Patent Laying-Open No. 10-068948).

With the reflective liquid crystal display device, however, it is not possible to see the images in the dark place, since it uses external light.

Further, with a normal transmissive liquid crystal display device, the images can be seen only when the backlight is on, which poses a problem of large power consumption by the backlight.

Furthermore, with the transmissive liquid crystal display device provided with a light-receiving window, although power consumption may be reduced, the movable blocking plate and a mechanism for driving the plate are required, resulting in a complicated configuration as well as degraded reliability of the device.

### SUMMARY OF THE INVENTION

In view of the foregoing, a major object of the present invention is to provide a liquid crystal display panel that is low in power consumption and simple in configuration, and a liquid crystal display device using the same.

A liquid crystal display panel according to the present invention is a transmissive liquid crystal display panel which includes: an image display portion including a plurality of first liquid crystal elements arranged in a matrix and each having controllable light transmittance, and for displaying an image; and a light-receiving window portion including at least one second liquid crystal element having controllable light transmittance, and for taking in external light to a backside of the liquid crystal display panel and using the external light to display the image on the image display portion.

Further, a liquid crystal display device according to the present invention includes: the liquid crystal display panel described above; and a backlight for irradiating a backside of the liquid crystal display panel with light to display an image on the image display portion.

According to the liquid crystal display panel and the liquid crystal display device of the present invention, it is possible to transmit or block external light by controlling light transmittance of the second liquid crystal element included in the light-receiving window portion. Thus, compared to the conventional case where external light is transmitted or blocked by opening/closing of a movable blocking plate, the configuration is simplified. Further, when the ambient light is sufficient, the images can be seen with the backlight turned off, so that power consumption is reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B show a configuration of a transmissive liquid crystal display device according to a first embodiment of the present invention.

FIG. 2 is a block diagram showing a main part of the transmissive liquid crystal display device shown in FIGS. 1A and 1B.

FIG. 3 shows the voltage-luminance characteristics of a liquid crystal element.

FIGS. 4A-4D show configurations of the surfaces of the TFT and color filter substrates shown in FIGS. 1A and 1B.

FIGS. 5A and 5B illustrate an operation of the transmissive liquid crystal display device shown in FIGS. 1A through 4D.

FIG. 6 is a circuit block diagram showing a main part of a transmissive liquid crystal display device according to a second embodiment of the present invention.

FIG. 7 is a circuit block diagram showing a main part of a transmissive liquid crystal display device according to a third embodiment of the present invention.

FIG. 8 is a circuit diagram showing a configuration of the precharge circuit shown in FIG. 7.

FIG. 9 is a time chart illustrating an operation of the precharge circuit shown in FIG. 8.

FIG. 10 is a circuit diagram showing a configuration of a drive circuit of a transmissive liquid crystal display device according to a fourth embodiment of the present invention.

FIG. 11 is a time chart illustrating an operation of the drive circuit shown in FIG. 10.

FIGS. 12A and 12B show a configuration of a light-receiving window portion of a transmissive liquid crystal display device according to a fifth embodiment of the present invention.

### DESCRIPTION OF THE PREFERRED EMBODIMENTS

### First Embodiment

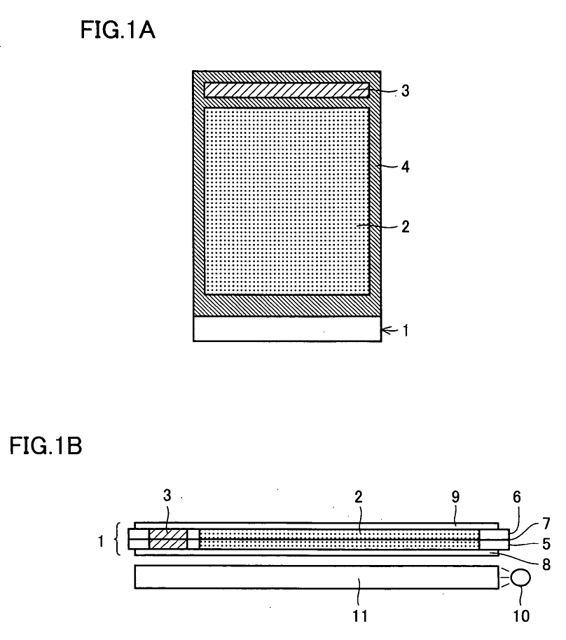

FIGS. 1A and 1B are a front view and a side view, respectively, of a transmissive liquid crystal display device according to a first embodiment of the present invention. In FIGS. 1A and 1B, the transmissive liquid crystal display device includes a liquid crystal display panel 1, a backlight 10, and a light guide/diffusion plate 11. An image display portion 2 is arranged at the center of liquid crystal display panel 1, and a light-receiving window portion 3 is arranged at the upper end of liquid crystal display panel 1. A black matrix 4 for blocking light is formed around image display portion 2 and around light-receiving window portion 3. Light-receiving window portion 3 may be arranged in any number and in any place around image display portion 2.

Image display portion 2 includes a plurality of liquid crystal elements arranged in a matrix. Light transmittance of each liquid crystal element is controllable. An image can be displayed by individually controlling the light transmittance of the plurality of liquid crystal elements of image display portion 2. Light-receiving window portion 3 includes a plurality of liquid crystal elements. Controlling the light transmittance of the plurality of liquid crystal elements of light-receiving window portion 3 makes it possible to take external light into the backside of liquid crystal display panel 1 or block the light.

Liquid crystal display panel 1 includes a TFT (thin film transistor) substrate 5, a color filter substrate 6, a liquid crystal 7, and polarizing plates 8 and 9. TFT substrate 5 is a glass substrate having a surface on which transparent electrodes and TFTs corresponding to the respective liquid crystal elements of image display portion 2 and light-receiving window portion 3 are formed. Color filter substrate 6 is a glass substrate having a surface on which color filters corresponding to the respective liquid crystal elements of image display portion 2 are formed, and a black matrix 4 is also formed between the neighboring color filters, around image display portion 2 and around light-receiving window portion 3. Further, opposite transparent electrodes corresponding to the respective liquid crystal elements of image display portion 2 and light-receiving window portion 3 are formed on the surfaces of the color filters and black matrix 4.

The surface of TFT substrate 5 and the surface of color filter substrate 6 are arranged at a prescribed distance via a spacer (not shown). Liquid crystal 7 is sealed between TFT substrate 5 and color filter substrate 6. Polarizing plate 8 is arranged on the backside of TFT substrate 5, and polarizing plate 9 is arranged on the backside of color filter substrate 6. Polarizing plates 8 and 9 are commonly provided for image display portion 2 and light-receiving window portion 3. When a voltage is applied between the transparent electrodes of a liquid crystal element, the state of polarization of liquid crystal 7 between the transparent electrodes changes in accordance with the level of the applied voltage. Light transmittance of the liquid crystal element changes according to the combination of polarization by polarizing plates 8, 9 and polarization by liquid crystal 7.

Light guide/diffusion plate 11 is arranged on the back of liquid crystal display panel 1, and backlight 10 is arranged to face an end surface of light guide/diffusion plate 11. Light guide/diffusion plate 11 guides and diffuses external light received via light-receiving window portion 3 across the entire back of liquid crystal display panel 1. Further, light guide/diffusion plate 11 guides and diffuses light received from backlight 10 via the end surface, across the entire back of liquid crystal display panel 1.

When the ambient light is insufficient, backlight 10 is turned on and light-receiving window portion 3 is set to a light-blocking state. The light from backlight 10 illuminates the entire backside of liquid crystal display panel 1 via light guide/diffusion plate 11, and an image is displayed on image display portion 2. At this time, since light-receiving window portion 3 is in the light-blocking state, escape of the light of backlight 10 via light-receiving window portion 3 to the outside is prevented, and thus, there is no degradation in display quality of image display portion 2. Alternatively, light-receiving window portion 3 may be set to a light-transmitting state, in which case the liquid crystal display device can be used as a lighting device.

When the ambient light is sufficient, backlight 10 is turned off and light-receiving window portion 3 is set to a light-transmitting state. With the function of light guide/diffusion plate 11, the external light illuminates the entire backside of liquid crystal display panel 1, and an image is displayed on image display portion 2. At this time, backlight 10 is turned off, which reduces power consumption.

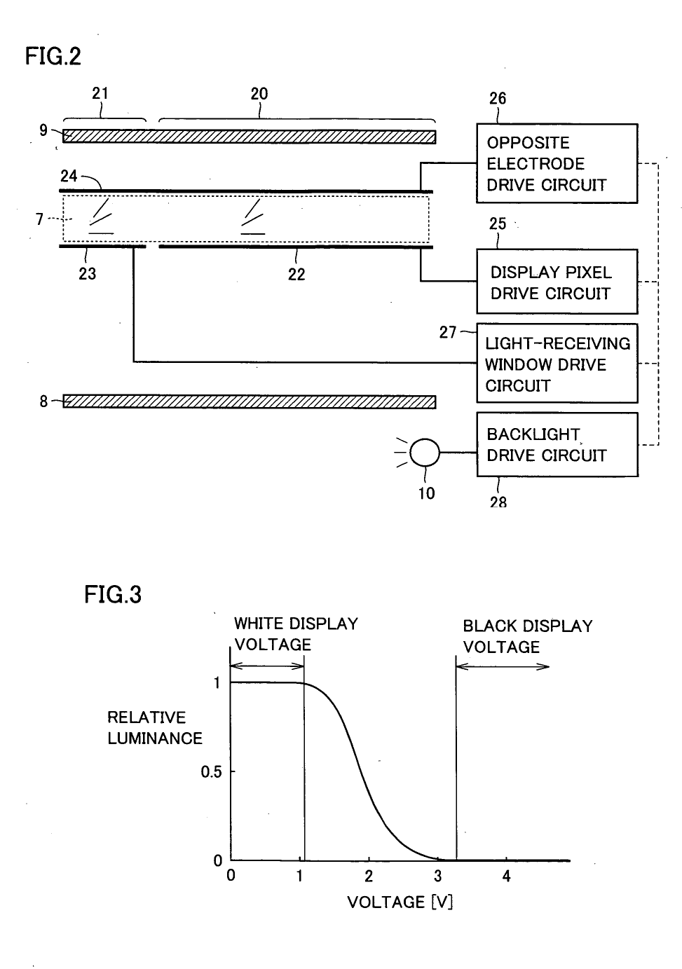

FIG. 2 shows a configuration of the transmissive liquid crystal display device shown in FIGS. 1A and 1B. In FIG. 2, one liquid crystal element 20 of image display portion 2 and one liquid crystal element 21 of light-receiving window portion 3 are shown. Transparent electrodes 22 and 23 are formed corresponding to liquid crystal elements 20 and 21, respectively, on the surface of TFT substrate 5. On the surface of color filter substrate 6, an opposite transparent electrode 24 is formed to face transparent electrodes 22 and 23. A display pixel drive circuit 25, a light-receiving window drive circuit 27, and an opposite electrode drive circuit 26 have their output nodes connected to transparent electrodes 22, 23 and 24, respectively. A backlight drive circuit 28 has its output node connected to backlight 10. Drive circuits 25-28 operate in synchronization.

Display pixel drive circuit 25 and opposite electrode drive circuit 26 apply a voltage of a level corresponding to an image signal between transparent electrode 22 and opposite transparent electrode 24. The state of polarization of liquid crystal 7 changes in response to the voltage level between transparent electrode 22 and opposite transparent electrode 24. Light transmittance of liquid crystal element 20 changes in accordance with the combination of the state of polarization of liquid crystal 7 and polarization of polarizing plates 8, 9. The polarity of the voltage between transparent electrodes 22 and 24 is reversed every prescribed period of time to prevent degradation in property of liquid crystal 7.

In the case where liquid crystal display panel 1 is of a typical active matrix type, display pixel drive circuit 25 includes a pixel transistor formed on TFT substrate 5 and connected to transparent electrode 22, a source driver IC, and a gate driver IC. Opposite electrode drive circuit 26 includes a power supply IC outputting a direct-current or alternating-current voltage.

Light-receiving window drive circuit 27 and opposite electrode drive circuit 26 apply a voltage for setting liquid crystal element 21 to a light-transmitting state or a light-blocking state between transparent electrode 23 and opposite transparent electrode 24. The state of polarization of liquid crystal 7 changes in accordance with the voltage level between transparent electrode 23 and opposite transparent electrode 24, and liquid crystal element 21 is set to a light-transmitting state or a light-blocking state in accordance with the combination of the state of polarization of liquid crystal 7 and polarization of polarizing plates 8, 9. The polarity of the voltage between transparent electrodes 23 and 24 is reversed every prescribed period of time to prevent degradation in property of liquid crystal 7.

FIG. 3 shows voltage-luminance characteristics of a typical liquid crystal element. Referring to FIG. 3, when the voltage is in a range of 0 V to 1 V, relative luminance is 1 (white display). When the voltage is in a range of 1 V to 3.3 V, relative luminance decreases as the voltage increases. When the voltage is equal to or more than 3.3 V, relative luminance is 0 (black display). Accordingly, the voltage being applied between transparent electrode 23 and opposite transparent electrode 24 in light-receiving window portion 3 only needs to have binary voltage levels of the voltage for displaying black and the voltage for displaying white.

Returning to FIG. 2, backlight drive circuit 28 turns on backlight 10 when the ambient light is insufficient, while it turns off backlight 10 when the ambient light is sufficient. Light-receiving window drive circuit 27 sets liquid crystal element 21 to the light-blocking state when backlight 10 is on, and sets liquid crystal element 21 to the light-transmitting state when backlight 10 is off.

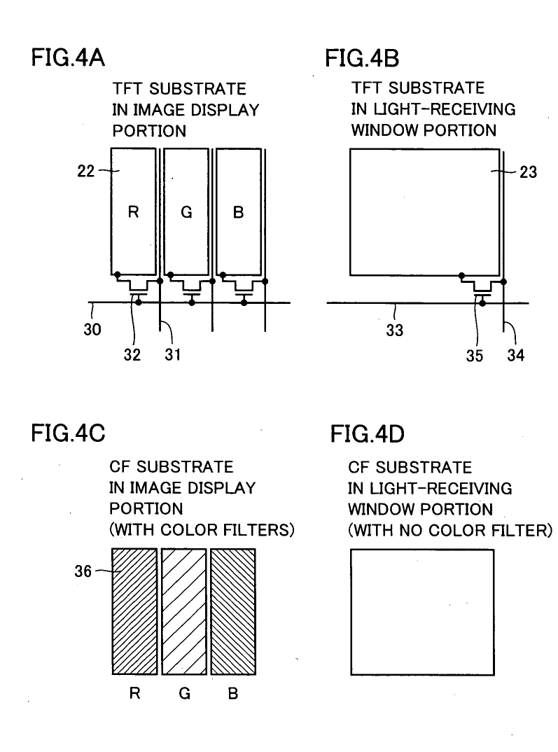

FIGS. 4A and 4B show the surface of TFT substrate 5, and FIGS. 4C and 4D show the surface of color filter substrate 6. More specifically, FIG. 4A shows three transparent electrodes 22 corresponding to liquid crystal elements 20 of R, G and B in image display portion 3. In reality, on the surface of TFT substrate 5 corresponding to image display portion 3, transparent electrodes 22 are arranged in rows and columns, and gate interconnections 30 corresponding to the respective rows, source interconnections 31 corresponding to the respective columns, and pixel transistors (N-type TFTs) 32 corresponding to respective transparent electrodes 22 are formed. Pixel transistor 32 is connected between corresponding transparent electrode 22 and corresponding source interconnection 31, and has its gate connected to corresponding gate interconnection 30.

When gate interconnection 30 is set to an “H” level of a selected level, each pixel transistor 32 corresponding to the relevant gate interconnection 30 is rendered conductive, and the voltage supplied from display pixel drive circuit 25 to each source interconnection 31 is applied to corresponding transparent electrode 22 via corresponding pixel transistor 32. When gate interconnection 30 is set to an “L” level of a non-selected level, each pixel transistor 32 is rendered non-conductive, and the voltage of each transparent electrode 22 is held.

FIG. 4B shows one transparent electrode 23 corresponding to one liquid crystal element 21 of light-receiving window portion 3. In reality, on the surface of TFT substrate 5 corresponding to light-receiving window portion 3, transparent electrodes 23 are arranged in rows and columns, and gate interconnections 33 corresponding to the respective rows, source interconnections 34 corresponding to the respective columns, and pixel transistors (N-type TFTs) 35 corresponding to respective transparent electrodes 23 are formed. Pixel transistor 35 is connected between corresponding transparent electrode 23 and corresponding source interconnection 34, and has its gate connected to corresponding gate interconnection 33.

Although the size of transparent electrode 23 of light-receiving window portion 3 may be equal to that of transparent electrode 22 of image display portion 2, it is preferable to make transparent electrode 23 larger than transparent electrode 22 for the purpose of taking in the external light efficiently. In FIGS. 4A and 4B, transparent electrode 23 has a size three times that of transparent electrode 22.

When gate interconnection 33 is set to an “H” level of the selected level, each pixel transistor 35 corresponding to the relevant gate interconnection 33 is rendered conductive, and the voltage provided from light-receiving window drive circuit 27 to each source interconnection 34 is applied to corresponding transparent electrode 23 via corresponding pixel transistor 35. When gate interconnection 33 is set to an “L” level of the non-selected level, each pixel transistor 35 is rendered non-conductive, and the voltage of each transparent electrode 23 is held.

FIG. 4C shows R, G and B color filters 36 corresponding to R, G and B liquid crystal elements 20 of image display portion 2. R, G and B color filters 36 enable display of a color image. Although the region of color filter substrate 6 corresponding to light-receiving window portion 3 may have a configuration similar to that of the region corresponding to image display portion 2, it is preferable not to provide color filter 36, as shown in FIG. 4D, for the purpose of efficiently taking in the external light.

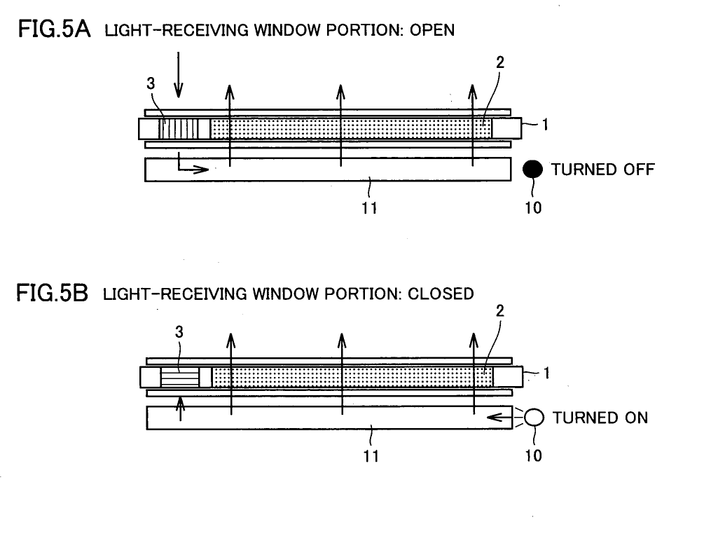

Hereinafter, an operation of the liquid crystal display device will be described. When the ambient light is sufficient, backlight 10 is turned off and light-receiving window portion 3 is set to a light-transmitting state (open), as shown in FIG. 5A. The external light transmitted through light-receiving window portion 3 illuminates the entire backside of liquid crystal display panel 1 via light guide/diffusion plate 11, so that an image is displayed on image display portion 2.

This can be adapted to display of standby screen in an application of a portable phone or the like. It is possible to display an image while reducing power consumption by turning off backlight 10.

In this case, as a way of driving image display portion 2, if a driving method not using halftones, such as an eight-color display mode, that is aiming at further reduction of power consumption and improvement of visibility, and that is high in contrast and can save the power consumed by a tone amplifier is used together, a more favorable effect can be expected.

When the ambient light is insufficient, backlight 10 is turned on and light-receiving window portion 3 is set to a light-blocking state (closed), as shown in FIG. 5B. The light from backlight 10 illuminates the entire backside of liquid crystal display panel 1 via light guide/diffusion plate 11, to display an image on image display portion 2. At this time, by setting light-receiving window portion 3 to the light-blocking state, it is possible to prevent escape of the light of backlight 10 from light-receiving window portion 3, so that degradation in display quality of image display portion 2 is prevented.

Although the switching timing between transmission and blocking of light-receiving window portion 3 may be set irrespective of the switching timing between off and on of backlight 10, synchronization of these switching timings ensures a more favorable effect of improving the display quality of image display portion 2 and others.

In the first embodiment, light-receiving window portion 3 is configured with liquid crystal elements 21. This simplifies the device configuration compared to the conventional case where a mechanical plate has been used to open/close the light-receiving window, so that reliability of the device can be improved.

Further, light-receiving window portion 3 can be controlled with only an electric signal, which ensures a quick response speed. It is thus readily possible to synchronize transmission/blocking of light-receiving window portion 3 with off/on of backlight 10.

Furthermore, since light-receiving window portion 3 is configured with the liquid crystal elements in the same manner as image display portion 2, a common power source and a common driving method can be used for driving both image display portion 2 and light-receiving window portion 3. This can reduce the device cost.

Still further, since polarizing plates 8 and 9 are commonly provided for image display portion 2 and light-receiving window portion 3, the number of parts, the material cost, and the number of assembly steps are all reduced.

It is noted that the liquid crystal of light-receiving window portion 3 may be a normally black liquid crystal that provides a black display when the driving voltage is low, or may be a normally white liquid crystal that provides a white display when the driving voltage is low. In order to reduce the power consumption when light-receiving window portion 3 is in the light-transmitting state, as in the case of display of a standby screen in the application of the portable phone or the like, it is desired to use the normally white liquid crystal. However, taking account of the fact that a flicker component is hardly visible on a white display of a normally black liquid crystal, if a driving method of lower power consumption, such as low frequency drive, is adapted as the driving method of light-receiving window portion 3, then the normally black liquid crystal may be used therefor.

Further, image display portion 2 and light-receiving window portion 3 may have separate polarizing plates. Still further, if image display portion 2 and light-receiving window portion 3 have separate seal members between substrates 5 and 6, and if a plurality of liquid crystal injection ports are provided to introduce the liquid crystal into the separate spaces, then it is possible to use the normally black liquid crystal for image display portion 2 and use the normally white liquid crystal for light-receiving window portion 3.

### Second Embodiment

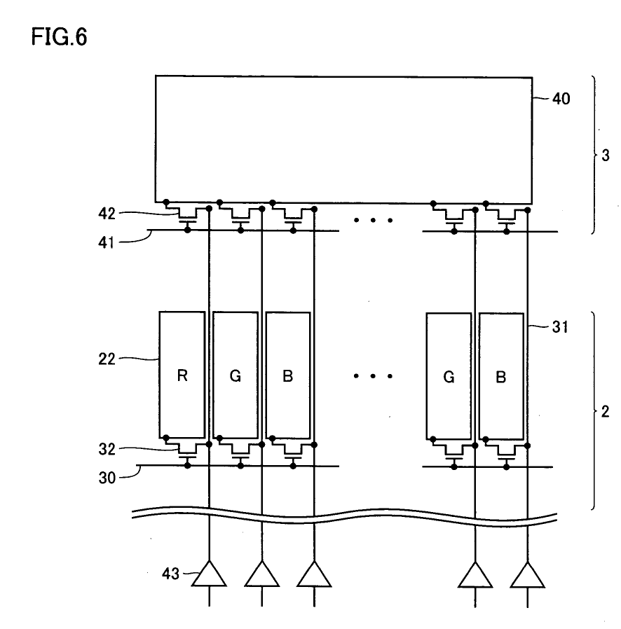

FIG. 6 shows a main part of a transmissive liquid crystal display device according to a second embodiment of the present invention. In FIG. 6, on the surface of TFT substrate 5 corresponding to image display portion 2, a plurality of transparent electrodes 22 arranged in rows and columns, gate interconnections 30 provided corresponding to the respective rows, source interconnections 31 provided corresponding to the respective columns, and pixel transistors 32 provided corresponding to respective transparent electrodes 22 are formed. Pixel transistor 32 is connected between corresponding transparent electrode 22 and corresponding source interconnection 31, and has its gate connected to corresponding gate interconnection 30.

Further, on the surface of TFT substrate 5 corresponding to light-receiving window portion 3, one transparent electrode 40, one gate interconnection 41, and pixel transistors (N-type TFTs) 42 provided corresponding to respective source interconnections 31 are formed. Each pixel transistor 42 is connected between transparent electrode 40 and an end of corresponding source interconnection 31, and has its gate connected to gate interconnection 41. The other end of each source interconnection 31 is connected to an output node of a corresponding source driver 43.

To set light-receiving window portion 3 to a light-transmitting state, gate interconnection 41 is set to an “H” level of the selected level during a dummy cycle at the end of a frame, and each pixel transistor 42 is rendered conductive. Each source driver 43 provides a white display voltage to transparent electrode 40 via corresponding source interconnection 31 and pixel transistor 42. When gate interconnection 41 is lowered to an “L” level of the non-selected level, the white display voltage is held by the capacitance between transparent electrode 40 and opposite transparent electrode 24. As such, the liquid crystal element of light-receiving window portion 3 attains a white display state, and light-receiving window portion 3 attains the light-transmitting state. To set light-receiving window portion 3 to a light-blocking state, a black display voltage, instead of the white display voltage, is provided to the transparent electrode, so that the liquid crystal element of light-receiving window portion 3 attains a black display state, and light-receiving window portion 3 attains the light-blocking state.

In the second embodiment, one transparent electrode 40 is provided for light-receiving window portion 3, and source interconnections 31 are shared with image display portion 2. Accordingly, addition of only one gate interconnection 41 and pixel transistors 42 for the line enables driving of light-receiving window portion 3. This can further simplify the device configuration.

Although one transparent electrode 40 has been provided in the second embodiment, transparent electrode 40 may be divided into a plurality of blocks, and a voltage may be applied only to necessary blocks in accordance with intensity of the ambient light. In this case, only the necessary blocks are driven, which can further reduce the power consumption.

### Third Embodiment

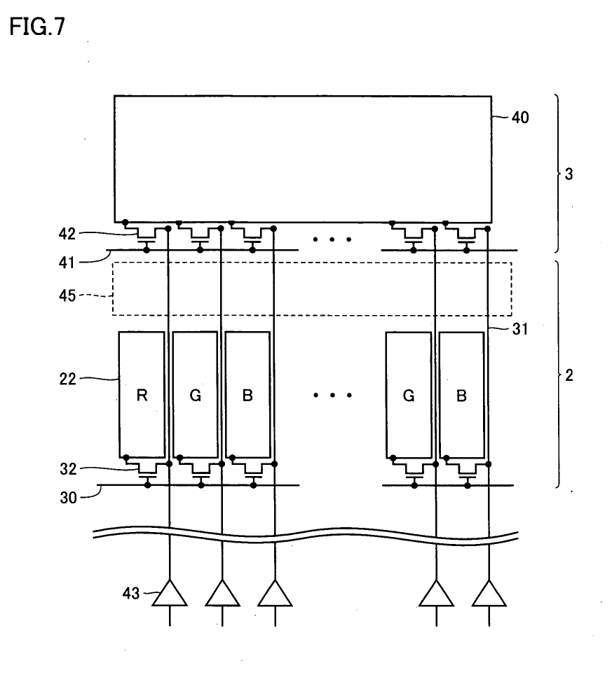

FIG. 7 shows a main part of a transmissive liquid crystal display device according to a third embodiment of the present invention, which is to be compared with FIG. 6. Referring to FIG. 7, this transmissive liquid crystal display device differs from the transmissive liquid crystal display device of FIG. 6 in that a precharge circuit 45 is additionally provided on the surface of TFT substrate 5 in a region between image display portion 2 and light-receiving window portion 3.

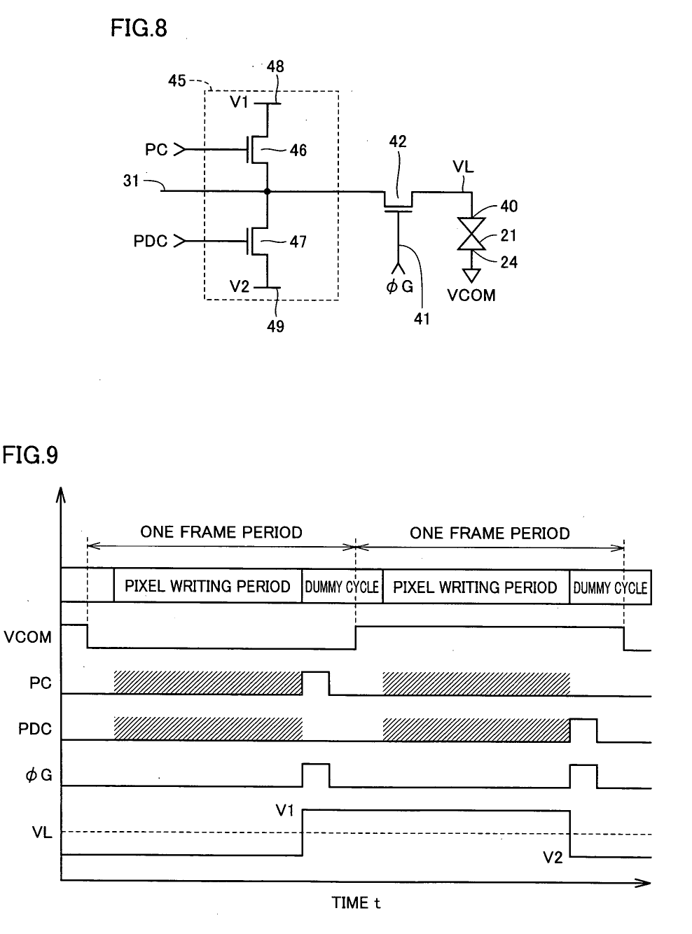

Precharge circuit 45 includes drive transistors (N-type TFTs) 46, 47 provided corresponding to each source interconnection 31, as shown in FIG. 8. Drive transistor 46 is connected between a line 48 of a power supply voltage V1 and corresponding source interconnection 31, and has its gate receiving a precharge control signal PC. Drive transistor 47 is connected between a line 49 of a power supply voltage V2 and corresponding source interconnection 31, and has its gate receiving a pre-discharge control signal PDC. Power supply voltage V1 becomes a positive black voltage/negative white voltage, and power supply voltage V2 becomes a positive white voltage/negative black voltage. It is noted that power supply voltages V1 and V2 are not the black display voltage and the white display voltage provided by source driver 43 to transparent electrode 22 of image display portion 2, but voltages at which the state of polarization of liquid crystal 7 begins to saturate (see FIG. 3).

When control signals PC and PDC are set to an “H” level and an “L” level, respectively, drive transistor 46 is rendered conductive and drive transistor 47 is rendered non-conductive, so that power supply-voltage V1 is applied to source interconnection 31. When control signals PC and PDC are set to an “L” level and an “H” level, respectively, drive transistor 47 is rendered conductive and drive transistor 46 is rendered non-conductive, and power supply voltage V2 is applied to source interconnection 31.

Pixel transistor 42 is connected between source interconnection 31 and transparent electrode 40 of liquid crystal element 21 of light-receiving window portion 3, and has its gate receiving a gate signal φG. Opposite transparent electrode 24 of liquid crystal element 21 receives a common voltage VCOM.

When gate signal φG attains an “H” level, pixel transistor 42 is rendered conductive, and a voltage VL of transparent electrode 40 of liquid crystal element 21 attains voltage V1 or V2 of source interconnection 31. When gate signal φG attains an “L” level, pixel transistor 42 is rendered non-conductive, and voltage VL of transparent electrode 40 of liquid crystal element 21 is held by the capacitance between transparent electrodes 40 and 24.

If VL−VCOM is positive, liquid crystal element 21 attains a black display (light-blocking state) when VL=V1 and a white display (light-transmitting state) when VL=V2. If VL−VCOM is negative, liquid crystal element 21 attains a white display when VL=V1 and a black display when VL=V2.

FIG. 9 is a time chart illustrating an operation of this transmissive liquid crystal display device. In FIG. 9, pixel writing periods and dummy cycles are provided alternately. A latter part of a dummy cycle, a pixel writing period, and an earlier part of the next dummy cycle constitute one frame period. Common voltage VCOM has its polarity changed from negative to positive or from positive to negative for each frame period. During the pixel writing period of one frame period, precharge circuit 45 is controlled by precharge control signal PC and pre-discharge control signal PDC, and each transparent electrode 22 of image display portion 2 is charged to power supply voltage V1 or V2, and then set to a voltage of the level corresponding to the image signal.

In the earlier part of the dummy cycle following the end of the pixel writing period, control signal PC or PDC is set to an “H” level for a prescribed period of time, and at the same time, gate signal φG is set to an “H” level for the prescribed period of time. Voltage VL of transparent electrode 40 of light-receiving window portion 3 is switched from V1 to V2 or from V2 to V1 for each frame period. To make light-receiving window portion 3 attain the light-blocking state, VL is set to V1 when common voltage VCOM is positive, and VL is set to V2 when common voltage VCOM is negative. To make light-receiving window portion 3 attain the light-transmitting state, VL is set to V2 when common voltage VCOM is positive, and VL is set to V1 when common voltage VCOM is negative.

In the third embodiment, light-receiving window portion 3 is driven, not by source driver 43, but by precharge circuit 45 that does not need a bias circuit or the like. This can reduce the power consumption.

### Fourth Embodiment

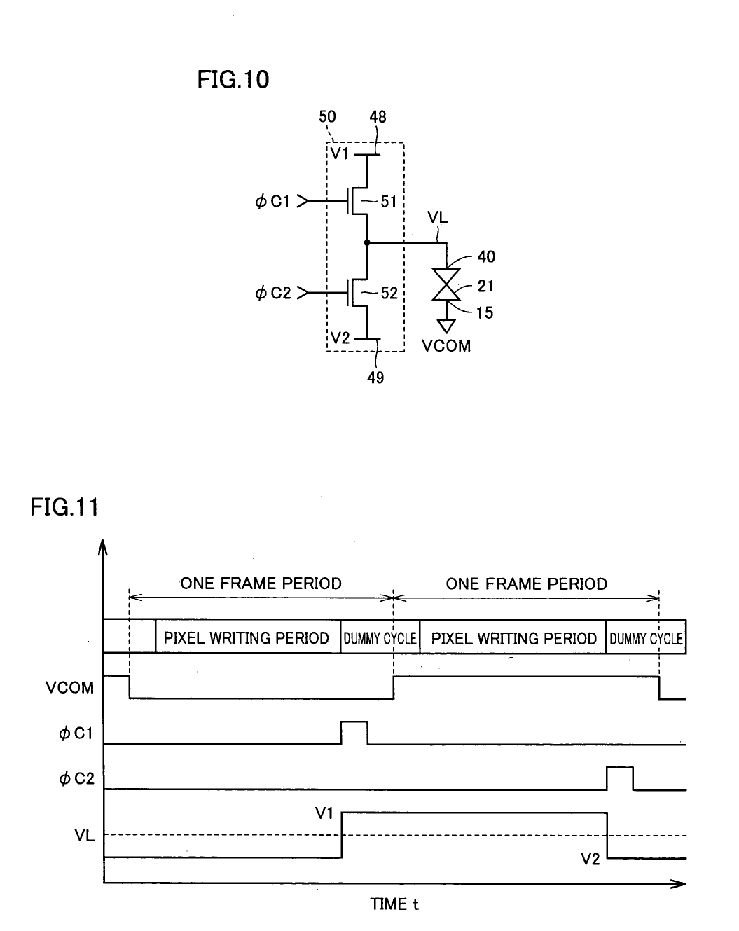

FIG. 10 shows a main part of a transmissive liquid crystal display device according to a fourth embodiment of the present invention, which is to be compared with FIG. 8. Referring to FIG. 10, this transmissive liquid crystal display device differs from the transmissive liquid crystal display device of FIG. 8 in that gate interconnection 41 and pixel transistor 42 for light-receiving window portion 3 are removed, and a drive circuit 50 dedicated to light-receiving window portion 3 is additionally provided.

Drive circuit 50 includes drive transistors (N-type TFTs) 51 and 52. Drive transistor 51 is connected between a line 48 of power supply voltage V1 and transparent electrode 40 of light-receiving window portion 3, and has its gate receiving a V1 control signal φC1. Drive transistor 52 is connected between a line 49 of power supply voltage V2 and transparent electrode 40, and has its gate receiving a V2 control signal φC2. Power supply voltages V1 and V2 are as described above in conjunction with FIG. 8.

When control signals φC1 and φC2 are set to an “H” level and an “L” level, respectively, drive transistor 51 is rendered conductive and drive transistor 52 is rendered non-conductive, and power supply voltage V1 is provided to transparent electrode 40. When control signals φC1 and φC2 are set to an “L” level and an “H” level, respectively, drive transistor 52 is rendered conductive and drive transistor 51 is rendered non-conductive, and power supply voltage V2 is provided to transparent electrode 40.

FIG. 11 is a time chart illustrating an operation of this transmissive liquid crystal display device. In FIG. 11, pixel writing periods and dummy cycles are provided alternately, and a latter part of a dummy cycle, a pixel writing period and an earlier part of the next dummy cycle constitute one frame period. Common voltage VCOM has its polarity switched from negative to positive or from positive to negative for each frame period.

In the earlier part of the dummy cycle following the end of the pixel writing period, control signal φC1 or φC2 is set to an “H” level for a prescribed period of time, and voltage VL of transparent electrode 40 of light-receiving window portion 3 is switched from V1 to V2 or from V2 to V1 for each frame period. To make light-receiving window portion 3 attain a light-blocking state, VL is set to V1 when common voltage VCOM is positive, and VL is set to V2 when common voltage VCOM is negative. To make light-receiving window portion 3 attain a light-transmitting state, VL is set to V2 when common voltage VCOM is positive, and VL is set to V1 when common voltage VCOM is negative.

In this case, V1 or V2 can be written in conformity with the polarity inversion of common voltage VCOM, not restricted to the dummy cycle. Although it is necessary to optimize the frequency of writing of V1, V2 in accordance with the voltage holding capability of liquid crystal element 21, the writing of V1, V2 may be carried out at a frequency lower than the switching frequency of common voltage VCOM, so as to reduce the power consumption by low-frequency drive. It should be noted that it is necessary to drive light-receiving window portion 3 using a voltage with which the voltage-transmittance characteristics of the liquid crystal become sufficiently saturated so as to prevent flickering of light-receiving window portion 3.

Further, in the case where light-receiving window portion 3 is provided independently from image display portion 2, V1, V2 can be written into liquid crystal element 21 of light-receiving window portion 3 at an independent timing irrespective of the writing period of image display portion 2.

Still further, in order to suppress leakage of liquid crystal element 21 of light-receiving window portion 3 at the time of low-frequency drive, it is also possible to provide an auxiliary capacitance and a TFT switch immediately beneath black matrix 4, connect the auxiliary capacitance and the TFT switch in series between transparent electrodes 40 and 15, and turn off the TFT switch during the time period except for the writing period. This facilitates implementation of the low-frequency drive.

### Fifth Embodiment

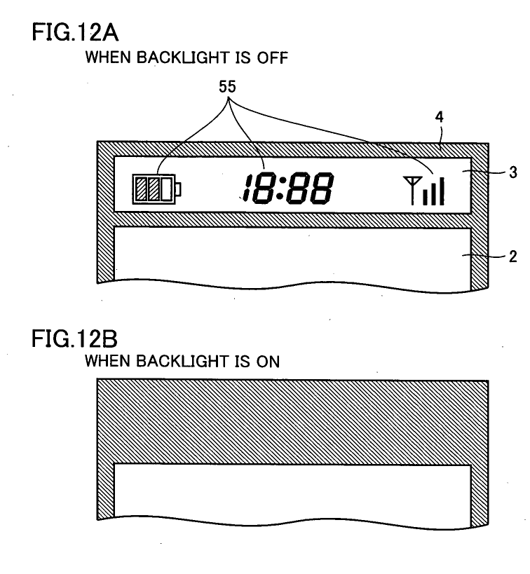

FIGS. 12A and 12B show a configuration of a light-receiving window portion 3 of a transmissive liquid crystal display device according to a fifth embodiment of the present invention. Referring to FIGS. 12A and 12B, light-receiving window portion 3 is provided with a fixed pattern 55 showing display of battery status, time, reception status and others. Fixed pattern 55 is configured with transmissive liquid crystal elements.

When backlight 10 is off, as shown in FIG. 12A, light-receiving window portion 3 produces a white display, and fixed pattern 55 is displayed. When backlight 10 is on, as shown in FIG. 12B, light-receiving window portion 3 entirely produces a black display, with fixed pattern 55 not being displayed.

In the fifth embodiment, fixed pattern 55 formed with the transmissive liquid crystal elements can be seen even if backlight 10 is off, so that the power consumption can be reduced.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A transmissive liquid crystal display panel, comprising:
an image display portion including a plurality of first liquid crystal elements arranged in a matrix and each having controllable light transmittance, and for displaying an image; and
a light-receiving window portion including at least one second liquid crystal element having controllable light transmittance, and for taking in external light to a backside of said liquid crystal display panel and using the external light to display said image on said image display portion.

2. The liquid crystal display panel according to claim 1, wherein
said liquid crystal display panel includes
a first glass substrate,
a plurality of first transparent electrodes formed in a first region on a surface of said first glass substrate corresponding to said plurality of first liquid crystal elements,
at least one second transparent electrode formed in a second region on the surface of said first glass substrate corresponding to said at least one second liquid crystal element,
a second glass substrate having a surface arranged to face the surface of said first glass substrate with a prescribed distance therebetween,
an opposite transparent electrode formed on the surface of said second glass substrate, and
a liquid crystal sealed between said first and second glass substrates.

3. The liquid crystal display panel according to claim 2, further comprising a plurality of color filters formed on the surface of said second glass substrate corresponding to said plurality of first liquid crystal elements, wherein
said color filter is not formed in a region corresponding to said light-receiving window portion.

4. The liquid crystal display panel according to claim 2, further comprising a black matrix for blocking light, formed on the surface of said second glass substrate in a region between said image display portion and said light-receiving window portion.

5. The liquid crystal display panel according to claim 2, further comprising:
a first polarizing plate arranged on a backside of said first glass substrate; and
a second polarizing plate arranged on a backside of said second glass substrate;
said first and second polarizing plates being provided commonly for said image display portion and said light-receiving window portion.

6. The liquid crystal display panel according to claim 1, wherein liquid crystal driving voltages for said second liquid crystal element at the time when said light-receiving window portion is in a light-transmitting state and in a light-blocking state are equal to liquid crystal driving voltages for said first liquid crystal element at the time when said image display portion provides a white display and a black display, respectively.

7. The liquid crystal display panel according to claim 1, wherein liquid crystal driving voltages for said second liquid crystal element at the time when said light-receiving window portion is in a light-transmitting state and in a light-blocking state are unequal to liquid crystal driving voltages for said first liquid crystal element at the time when said image display portion provides a white display and a black display, respectively.

8. The liquid crystal display panel according to claim 1, wherein a liquid crystal driving frequency for said second liquid crystal element and a liquid crystal driving frequency for said first liquid crystal element are equal.

9. The liquid crystal display panel according to claim 1, wherein a liquid crystal driving frequency for said second liquid crystal element and a liquid crystal driving frequency for said first liquid crystal element are unequal.

10. The liquid crystal display panel according to claim 1, wherein said light-receiving window portion further includes a fixed pattern display portion for displaying prescribed information.

11. A liquid crystal display device comprising:
the liquid crystal display panel recited in claim 1; and
a backlight for irradiating a backside of said liquid crystal display panel with light to display an image on said image display portion.

12. The liquid crystal display device according to claim 11, further comprising:
a first drive circuit for selectively driving said light-receiving window portion to one of a light-transmitting state and a light-blocking state; and
a second drive circuit for selectively driving said backlight to one of an off state and an on state; wherein
switching between the light-transmitting state and the light-blocking state of said light-receiving window portion by said first drive circuit is carried out in synchronization with switching between the off state and the on state of said backlight by said second drive circuit.
